(19) United States
(12) Patent Application Publication
(10) Pub. No.: US 2003/0035136 A1
(43) Pub. Date: Feb. 20, 2003

(54) Printing order reception method and apparatus

(75) Inventors: Katsumi Yamagishi, Minato-ku (JP); Fumihiro Nakano, Minato-ku (JP); Hideaki Sogawa, Setagaya-ku (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/014,530

(22) Filed: Dec. 14, 2001

(30) Foreign Application Priority Data
Aug. 15, 2001 (JP) 2001-246732

(51) Int. Cl. B41J 1/00; G06F 15/00

(52) U.S. Cl. 358/1.15; 358/1.13

(57) ABSTRACT

A printing order reception apparatus 101 stores print content data and print attribute data, which are used for the printing of multiple types of materials. Upon receiving a printing order from a client apparatus 102, the printing order reception apparatus 101 generates a print image, based on the print content data and the print attribute data, and transmits the print image to the client apparatus 102. The orderer then employs the client apparatus 102 to edit the print image and to transmit it to the printing order reception apparatus 101, which thereafter transmits the edited print image to a printing machine 103 and stores the newly set print content data and print attribute data.

### BACKGROUND OF THE INVENTION

1. Filed of the Invention

The present invention relates to a printing order reception method and an apparatus therefor and particularly relates to a printing order reception method for enabling to place and accept a printing order between a customer and a company via a network.

2. Description of the Related Art

Generally, an order for printing and acceptance for printing is a method in which person placing the order either carries or mails to a printing company a material to be printed and approves a proof of the material prepared by the printing company to print the material.

In recent times, utilizing methods for placing and accepting printing orders via networks has increased. For example, several kinds of printed matter templates, which are prepared in a printing order reception apparatus of a printing company, are transmitted via a network to a terminal device of an oderer. The orderer then selects a preferred template from the several types of printed matter templates, input print content data to be printed (character data and the like), and transmits the data and the template selection result to the printing order reception apparatus. The printing company generates print data of the printed matter based on the received template and the print content data to print the printed matter while storing the generated print data of the printed matter and the print contents data in the printing order reception apparatus. Thereafter, when re-order for printing the same printed matter is received, reprint is performed based on the print data of the printed matter and the print content data, which are stored in the printing order reception apparatus.

Further, in case that printed matter owned by an orderer is reprinted, the orderer mail the owned printed matter to the printing company. The printing company reprints the printed matter mailed from the orderer and generates print data of the printed matter by using a scanner or the like to store the generated print data of the printed matter and print content data printed on the printed matter in the printing order reception apparatus. When re-order for printing the same printed matter is received, reprint is performed based on the print data of the printed matter and the print content data, which are stored in the printing order reception apparatus. In this case, the print content data printed on the printed matter includes, in addition to the character information, image data of complicated mark such as logo (symbol mark of a company) or the like.

Reprinting the same type of printed matter can be performed by using or modifying the stored print data of the printed matter and the stored print content data. However, printing other type of printed matter can not be performed by using or modifying the stored print data of the printed matter and the stored print content data. For example, an envelop, a postcard, receipt, and the like can not be printed by using print data and print content data of a business card.

Furthermore, in addition to the character information, the image data of the complicated mark such as a logo and the like can be stored by a scanner or the like as print content data which is printed on the printed matter mailed from the orderer. However, it is impossible to modify the stored image data of the logo or the like to print the image data on other types of printed matter. For example, if a small logo mark printed on a business card is directly printed on an envelop, a postcard, a receipt, and the like, a balance for the printed matters can not be kept.

### SUMMARY OF THE INVENTION

It is, therefore, an objective of the present invention to provide a printing order reception method which can print another type of printed matter by utilizing print data of a printed matter stored in a printing order reception apparatus and an apparatus therefor.

According to a first aspect of the invention, there is provided a printing order reception method for accepting an order of a printed matter via network comprising the steps of:

storing print content data used in a case of printing a first type of printing medium;

generating print data to be printed on a second type of printing medium by using the stored print content data; and

transmitting the generated print data to an external device.

According to a second aspect of the invention, there is provided the printing order reception method according to the first aspect of the invention, further comprising the steps of:

generating a print image to be printed on the second type of printing medium; and

transmitting the generated print image to a network terminal.

According to a third aspect of the invention, there is provided the printing order reception method according to the second aspect of the invention, further comprising the steps of storing attribute information of the print content data; and

generating the print image by using at least a part of the attribute information stored.

According to a fourth aspect of the invention, there is provided the printing order reception method according to the second aspect of the invention, further comprising the step of:

copying at least a part of the attribute information as second attribute information.

According to a fifth aspect of the invention, there is provided the printing order reception method according to the fourth aspect of the invention, further comprising the step of:

generating the print image by using the second attribute information.

According to a sixth aspect of the invention, there is provided the printing order reception method according to the fourth aspect of the invention, further comprising the steps of:

accepting instruction information instructing correction of the second attribute information from the network terminal; and

correcting the second attribute information in accordance with the accepted instruction information.

According to a seventh aspect of the invention, there is provided the printing order reception method according to the third aspect of the invention, further comprising the step of:

generating the print image by using the attribute information and attribute information stored in advance and used for the generation of the print data.

According to an eighth aspect of the invention, there is provided the printing order reception method according to the third aspect of the invention, further comprising the steps of:

receiving instruction information instructing correction of the attribute information from the network terminal; and

storing the received instruction information.

According to a ninth aspect of the invention, there is provided the printing order reception method according to the third aspect of the invention, further comprising the steps of:

receiving instruction information instructing correction of the attribute information from the network terminal;

regenerating the print image in accordance with the received instruction information; and

transmitting the regenerated print image to the network terminal.

According to a tenth aspect of the invention, there is provided the printing order reception method according to the third aspect of the invention, further comprising the steps of:

receiving instruction information instructing correction of the attribute information from the network terminal; and

generating the print data in accordance with the received instruction information.

According to an eleventh aspect of the invention, there is provided the printing order reception method according to the second aspect of the invention, wherein the print image is the same as the print data.

According to a twelfth aspect of the invention, there is provided the printing order reception method according to the first aspect of the invention, further comprising the steps of:

storing attribute information of the print content data used to print the first type of printing medium; and

generating the print data by using at least a part of the stored attribute information.

According to a thirteenth aspect of the invention, there is provided the printing order reception method according to the twelfth aspect of the invention, further comprising the step of:

copying at least a part of the attribute information as second attribute information.

According to a fourteenth aspect of the invention, there is provided the printing order reception method according to the thirteenth aspect of the invention, further comprising the step of:

generating the print data by using the second attribute information.

According to a fifteenth aspect of the invention, there is provided the printing order reception method according to the twelfth aspect of the invention, further comprising the step of:

generating the print image by using the attribute information and attribute information stored in advance and used for the generation of the print data.

According to a sixteenth aspect of the invention, there is provided a printing order reception apparatus for accepting an order of a printed matter via a network comprising:

a print content data storage unit for storing print content data used when printing a first type of printing medium;

a print data generation unit for employing the print content data stored by the print content data storage unit to generate print data to be printed on a second type of printing medium; and

an external apparatus transmission unit for transmitting the print data generated by the print data generation unit to an external device.

According to a seventeenth aspect of the invention, there is provided the printing order reception apparatus according to the sixteenth aspect of the invention, further comprising:

a print image generation unit for generating a print image to be printed on the second type of printing medium; and

a network terminal transmission unit for transmitting the print image generated by the print image generation unit to a network terminal.

According to an eighteenth aspect of the invention, there is provided the printing order reception apparatus according to the seventeenth aspect of the invention, further comprising an attribute information storage unit for storing attribute information of the print content data,

wherein the print image generation unit generates the print image by using at the least a part of the attribute information stored in the attribute information storage unit.

According to a nineteenth aspect of the invention, there is provided the printing order reception apparatus according to the eighteenth aspect of the invention, further comprising a copying unit for copying at least a part of the attribute information as second attribute information.

According to a twentieth aspect of the invention, there is provided the printing order reception apparatus according to the nineteenth aspect of the invention, wherein the print image generation unit employs the second attribute information to generate the print image.

According to a twenty-first aspect of the invention, there is provided the printing order reception apparatus according to the nineteenth aspect of the invention, further comprising:

an instruction information acceptance unit for accepting instruction information instructing correction of the second attribute information from the network terminal; and

a second attribute information correction unit for correcting the second attribute information in accordance with the instruction information accepted by the instruction information acceptance unit.

According to a twenty-second aspect of the invention, there is provided the printing order reception apparatus according to the eighteenth aspect of the invention, wherein the print image generation unit generates the print image by using the attribute information and attribute information stored in advance and used for the generation of the print data.

According to a twenty-third aspect of the invention, there is provided the printing order reception apparatus according to the eighteenth aspect of the invention, further comprising:

an instruction information acceptance unit for receiving instruction information instructing correction of the attribute information from the network terminal; and

an instruction information storage unit for storing the instruction information received by the instruction information acceptance unit.

According to a twenty-fourth aspect of the invention, there is provided the printing order reception apparatus according to the eighteenth aspect of the invention, further comprising:

an instruction information acceptance unit for receiving instruction information instructing correction of the attribute information from the network terminal; and

a print image regeneration unit for regenerating the print image in accordance with the instruction information received by the instruction information acceptance unit,

wherein the network terminal transmission unit transmits the print image regenerated by the print image regeneration unit to the network terminal.

According to a twenty-fifth aspect of the invention, there is provided the printing order reception apparatus according to the eighteenth aspect of the invention, further comprising an instruction information acceptance unit for receiving instruction information instructing correction of the attribute information from the network terminal,

wherein the print data generation unit generates the print data in accordance with the instruction information received by the instruction information acceptance unit.

According to a twenty-sixth aspect of the invention, there is provided the printing order reception apparatus according to the seventeenth aspect of the invention, wherein the print image is the same as the print data.

According to a twenty-seventh aspect of the invention, there is provided the printing order reception apparatus according to the sixteenth aspect of the invention, further comprising an attribute information storage unit for storing attribute information of the print content data used to print the first type of printing medium,

wherein the print data generation unit generates the print data by using at least a part of the attribute information stored in the attribute information storage unit.

According to a twenty-eighth aspect of the invention, there is provided the printing order reception apparatus according to the twenty-seventh aspect of the invention, further comprising a copying unit for copying at least a part of the attribute information as second attribute information.

According to a twenty-ninth aspect of the invention, there is provided the printing order reception apparatus according to the twenty-eighth aspect of the invention, wherein the print data generation unit employs the second attribute information to generate the print data.

According to a thirtieth aspect of the invention, there is provided the printing order reception apparatus according to the twenty-seventh aspect of the invention, further comprising a print image generation unit for generating the print image by using the attribute information and attribute information stored in advance and used for the generation of the print data.

### BRIEF DESCRIPTION OF THE DRAWINGS

FIG. 1 is a conceptual diagram showing an example configuration for a printing order reception system according to the present invention.

FIG. 2 is a diagram showing an example of print content data table 201 of a business card that is stored in a printing order reception apparatus 101.

FIG. 3 is a diagram showing an example of print attribute data table 301 of a business card that is stored in the printing order reception apparatus 101.

FIG. 4 is a diagram showing an example of a copy print attribute data table 401 of a business card that is stored in the printing order reception apparatus 101.

FIG. 5 is a diagram showing an example of “initial menu” screen 501 that is displayed on a client apparatus 102.

FIG. 6 is a diagram showing an example of “template setting” screen 601 that is displayed on the client apparatus 102.

FIG. 7 is a diagram showing an example of “character information content setting” screen 701 that is displayed on the client apparatus 102.

FIG. 8 is a diagram showing an example of “paper setting” screen 801 that is displayed on the client apparatus 102.

FIG. 9 is a diagram showing an example of “print image” screen 901 that is displayed on the client apparatus 102.

FIG. 10 is a diagram showing an example of “order reception” screen 1001 that is displayed on the client apparatus 102.

FIG. 11 is a diagram showing an example of “print image confirmation” screen 1101 that is displayed on the client apparatus 102.

FIG. 12 is a diagram showing an example of “character information content setting” screen 1201 that is displayed on the client apparatus 102.

FIG. 13 is a diagram showing an example of “character information attribute setting” screen 1301 that is displayed on the client apparatus 102.

FIG. 14 is a diagram showing an example of “logo setting” screen 1401 that is displayed on the client apparatus 102.

FIG. 15 is a diagram showing an example of “location setting” screen 1501 that is displayed on the client apparatus 102.

FIG. 16 is a diagram showing an example of “print image confirmation” screen 1601 that is displayed on the client apparatus 102.

FIG. 17 is a flow chart showing a flow of process performed by the printing order reception apparatus 101.

FIG. 18 is a block diagram showing an inner structure of the printing order reception apparatus 101.

### DETAILED DESCRIPTION OF THE PREFERRED EMBODIMENTS

A printing order reception method according to an embodiment of the present invention will now be described in detail with reference to the accompanying drawings.

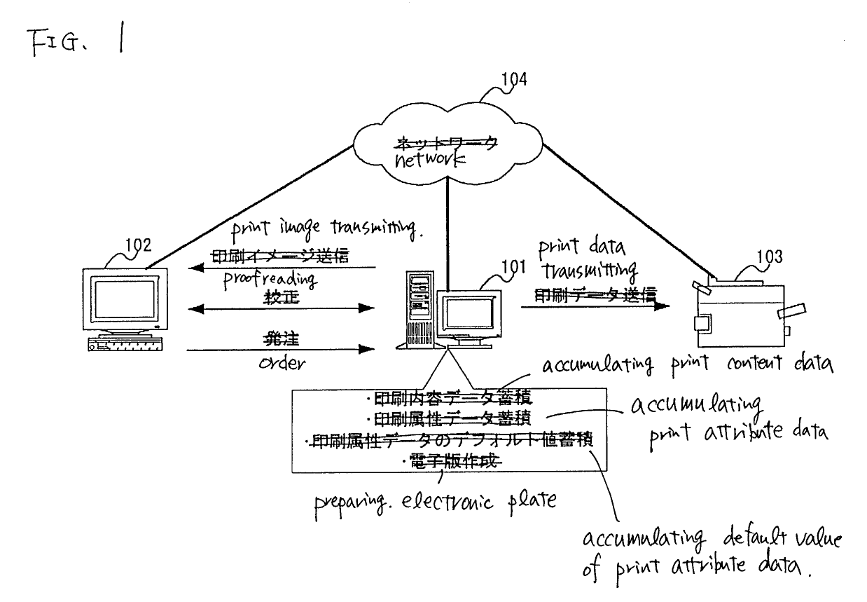

FIG. 1 is a conceptual diagram showing an example of configuration of a printing order reception system according to the invention.

As is shown in FIG. 1, a printing order reception system according to the invention comprises a printing order reception apparatus 101, a client apparatus 102 and a printing machine 103, all of which are connected via a network 104. The network 104 includes the Internet, a LAN (Local Area Network), a WAN (Wide Area Network), and the like. The client apparatus 102 is a PC (Personal Computer) or the like owned by an individual or a corporation.

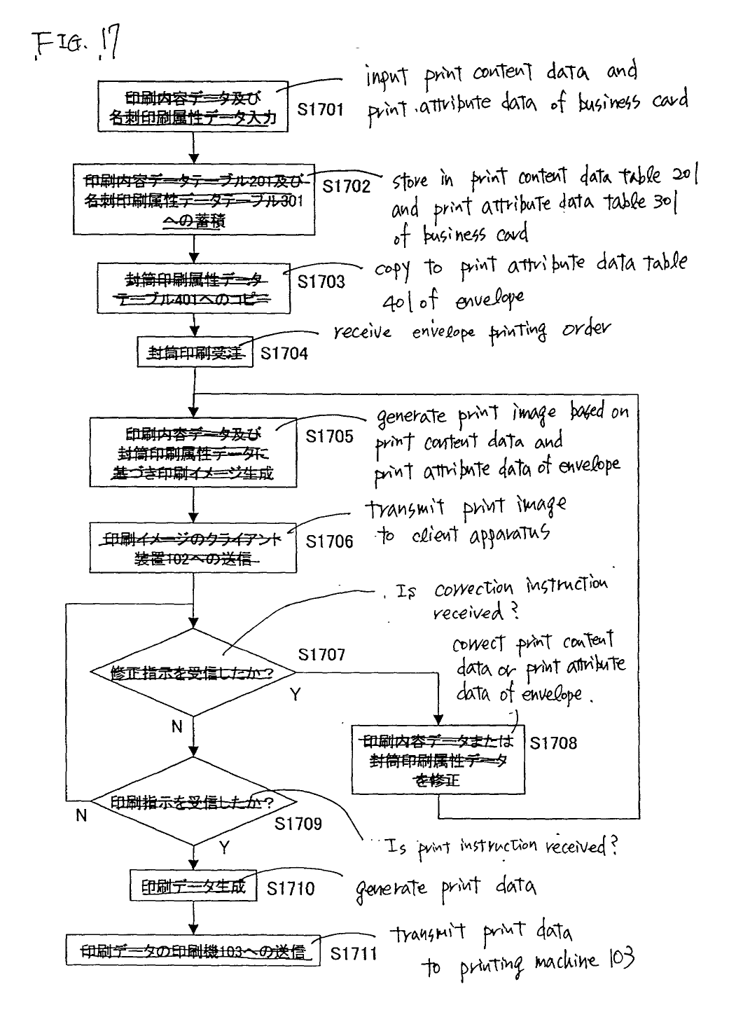

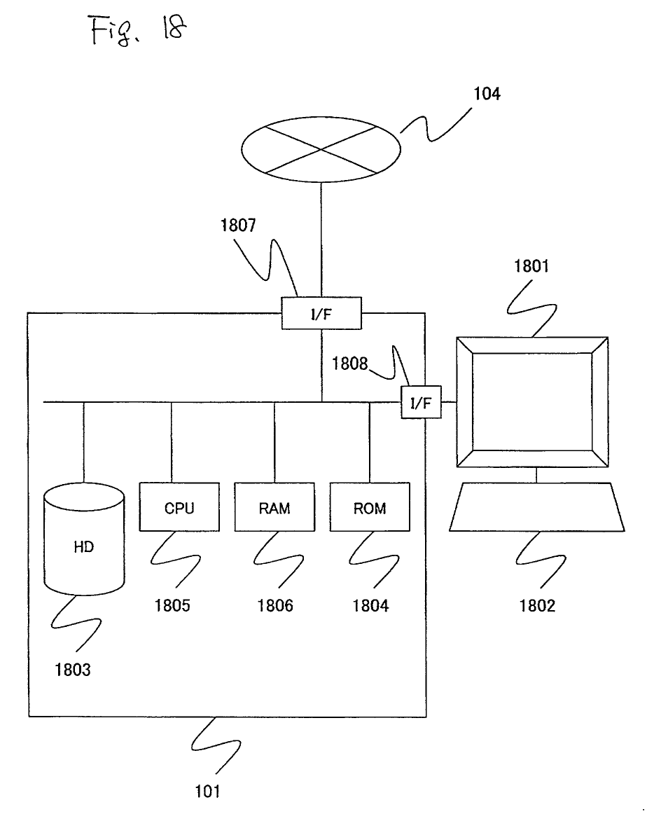

Now, with reference to FIGS. 17, 18 and other drawings, The printing order reception system of the invention will be explained for a case wherein print content data (character information and image data of a logo) of a business card, which are obtained from an order for printing the business card, and print attribute data (attribute information of an electronic plate) are employed for printing an envelope as an embodiment. Incidentally, FIG. 17 is a flow chart showing a flow of process performed by the printing order reception apparatus 101. FIG. 18 is a block diagram showing an inner structure of the printing order reception apparatus 101. In FIG. 17, a display 1801 and a keyboard 1802 are externally connected to the printing order reception apparatus 101 via an I/F 1808. However, the printing order reception apparatus 101, the display 1801, and the keyboard 1802 may be formed integrally.

The printing order reception apparatus 101 generates print data of business card based on print content data of business card and print attribute data which are obtained by being inputted on a web from the client apparatus 102 or the like and transmits the generated print data (character information, image data of a logo and the electronic plate) to the printing machine 103 via the network 104. The printing order processing apparatus 101 stores the print content data and the print attribute data of the business card in a HD (Hard Disk) or the like (S1701, S1702). It should be noted that the print content data and the print attribute data may be stored in a HD 1803 of the printing order reception apparatus 101 or may be stored in a HD connected to the network 104 via the network 104.

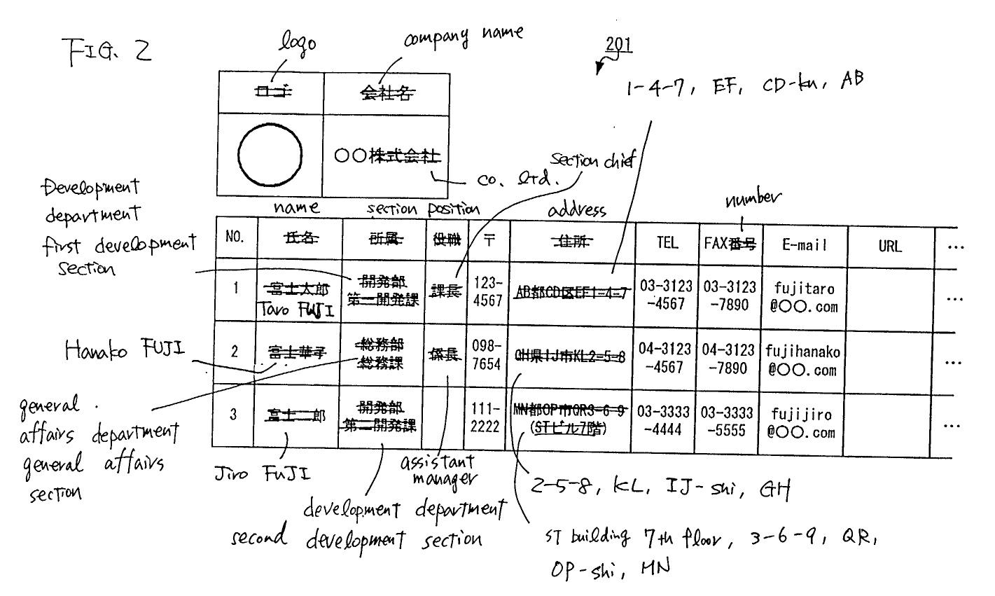

FIG. 2 is a diagram showing a print content data table 201 of business cards that is stored in the HD 1803 of the printing order reception apparatus 101.

As is shown in FIG. 2, image data of a logo such as a symbol mark and the like that is representative of a company and character information are stored in the print content data table 201.

In this embodiment, image data of the logo for the “OO Co., Ltd.” and character information of the business cards of the OO Co., Ltd. employees “Taro FUJI”, “Hanako FUJI” and “Jiro FUJI”, i.e., company name, a personal name, a company section, a job position, a postal code, an address, a telephone number, a facsimile number, an e-mail address, a URL, and the like are stored in the print content data table 201 of business cards. However, the print content data table 201 may accumulate other character information than the above. Here, since in this case no URLs are printed on the business cards, the URL column is empty.

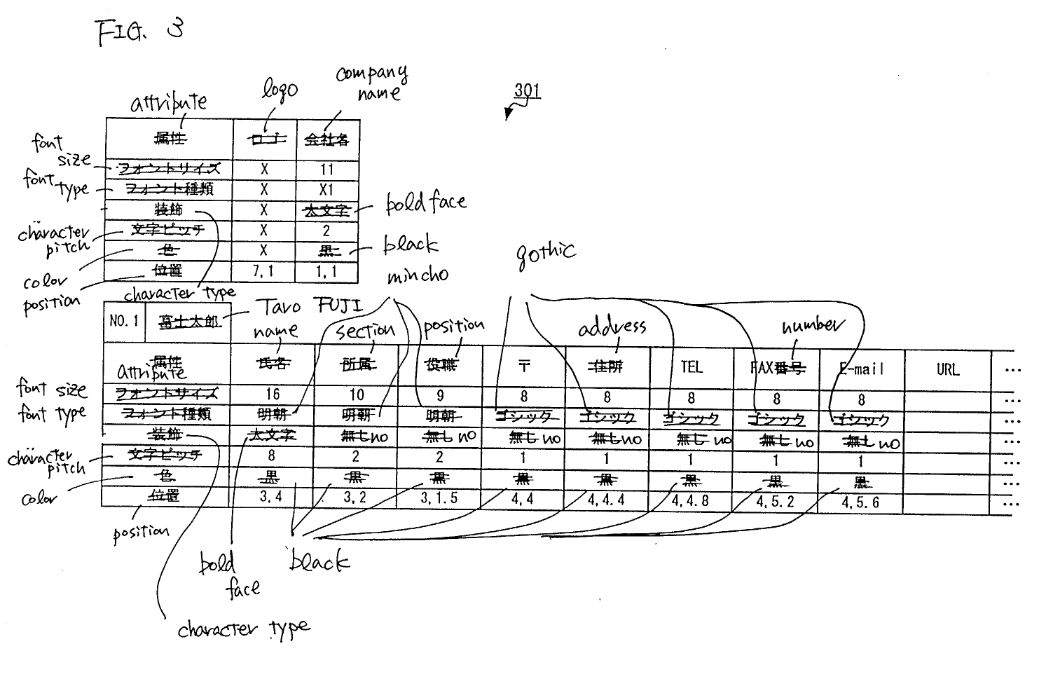

FIG. 3 is a diagram showing an example print of attribute data table 301 of business cards accumulated in the HD 1803 of the printing order reception apparatus 101.

As is shown in FIG. 3, attribute information (font size, font type, character type, character pitch, color, and position) in an electronic plate is also accumulated in the print attribute data table 301 of business cards.

In this embodiment, the print attribute data (position) of the image data of a logo and the attribute data (font size, font type, character type, character pitch, color and position) of the business card of “Taro Fuji” are stored in the print attribute data table 301. Since print attribute data other than “position” (font size and type, character type, character pitch and color) can not be set for the image data of the logo, an “X” is inputted in these columns. Further, since a URL is not printed on the business card, the URL column in the table 301 is empty as well as in the print content data table 201.

In addition to the print attribute data table 301 of business cards, the HD 1803 of the printing order reception apparatus 101 accumulates a print attribute data table for each print material type.

Further, the HD 1803 of the printing order reception apparatus 101 sets and stores default values in advance in the print attribute data table of multiple types of printed matters (for example, business cards, envelopes, postcards, vouchers). It should be noted, however, that a default value need not be inputted in all the columns.

When the print attribute data of a business card is obtained, the print attribute data of the business card is accumulated in the print attribute data table. Then, part of the obtained print attribute data is copied to and accumulated in a print attribute data table of another type of printed matter, for example, an envelope (S1703). At this time, default values may be overwritten or data may be accumulated in columns wherein no values were stored originally.

An explanation will now be given on a print attribute data table 401 of an envelope to which the print attribute data of a business card is copied.

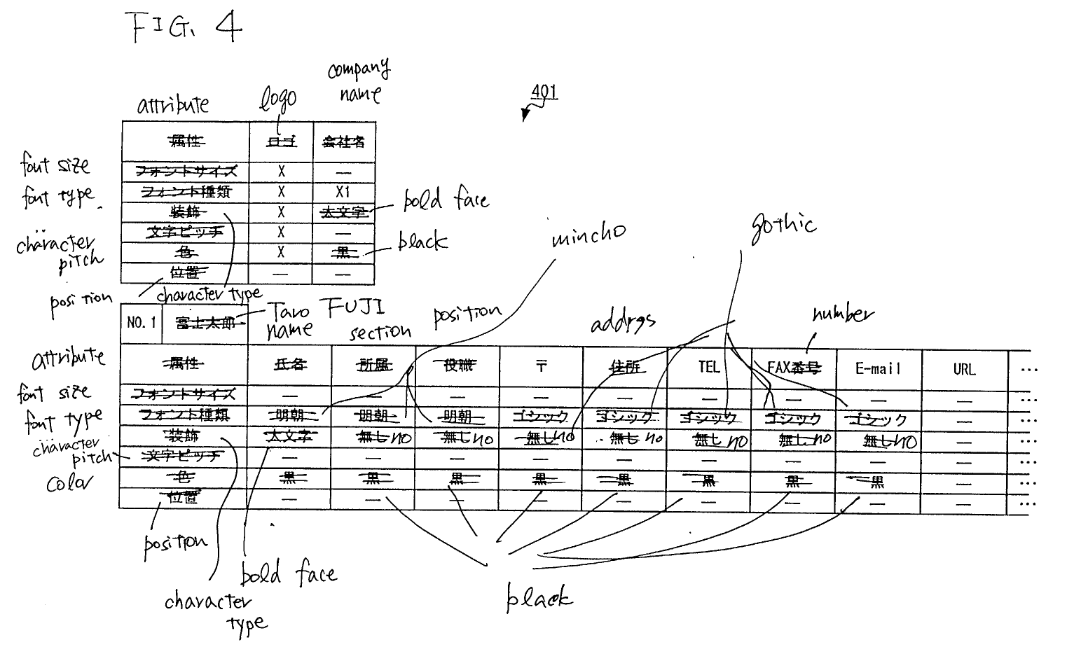

FIG. 4 is a diagram showing the print attribute data table 401 of an envelope to which part of the print attribute data of a business card, which is accumulated in the HD 1803 of the printing order reception apparatus 101, is copied.

As is shown in FIG. 4, in the print attribute data table 401 of the envelope to which part of the print attribute data of the business card is copied, the same values as the print attribute data (font type, character type, and color) of the business card in FIG. 3 are inputted as the print attribute data (font type, character type and color) of character information. Further, instead of the values of the print attribute data (font size, character pitch and position) of the business card, the default values are inputted in the print attribute data (position) of the image data of a logo and the print attribute data (font size, character pitch and position) of character information. In this embodiment, the default value is indicated by a “-” (hyphen).

When the order printing reception apparatus 101 receives an envelope printing order from the client apparatus 102 via the network 104 (S1704), the printing order reception apparatus 101 generates a print image based on the accumulated print content data of the business cards and the print attribute data of an envelope to which part of the print attribute data of the business card is copied (S1705) and transmits the generated print image to the client apparatus 102 via the network 104 (S1706). Therefore, the print image is generated by using the default print attribute data and the print attribute data that is copied. When the print attribute data is not copied, the print image is generated based on the default print attribute data. The print image is a GIF image, a JPEG image, a PDF image, or the like that can be confirmed by being displayed on the Web screen of the client apparatus 102. A generation program for generating this print image is stored in a ROM 1804. In accordance with this generation program, a CPU 1805 generates the print image based on the print content data and the print attribute data of the envelope stored in the HD 1803. The generated print image is stored in a RAM 1806 or the HD 1803 and is transmitted to the client apparatus 102 via the I/F 1807.

An orderer operating the client apparatus 102 refers to the received print image to adjust (proof) the print content data (character information and image data of a logo) and the print attribute data (font size and type, character type, character pitch, color and position). The client apparatus 102 then transmits the resultant print content data and the print attribute data to the printing order reception apparatus 101 via the network 104.

When the printing order reception apparatus 101 receives this correction (adjustment) instruction (S1707), the printing order reception apparatus 101 reflects the thus adjusted print content data and print attribute data in the print content data table 201 and the print attribute data table 301 of an envelope to correct (S1708), generates a print image based on the corrected print content data and the corrected print attribute data of the envelope (S1705), and transmits the print image to the client apparatus 102 via the network 104 (S1706).

When the orderer refers to the received print image and confirms that no editing is required for the print content data and the print attribute data, the orderer transmits to the printing order reception apparatus 101 an instruction for printing the print image (S1709).

Upon receiving the printing instruction, the printing order reception apparatus 101 generates an electronic plate based on the print attribute data of an envelope adjusted by the orderer, generates print data by adding the print content data of the envelope reflected on the electronic plate (S1710), and transmits the thus obtained print data to the printing machine 103 (S1711).

A print attribute data table in which a part of the print attribute data obtained adjusted by the orderer is copied to the print attribute data set default values of a printed matter other than an envelope is generated to accumulate the generated print attribute data table.

In relation to the print order reception sysmte according to the invention, a description will now be given on a specific example of a case that the print content data (character information and image data for a logo) and the print attribute data (attribute information for an electronic plate) of a business card, which is obtained from an order for printing of a business card, are employed to print an envelope.

The orderer, who issued a first order for printing a business card to the printing order reception apparatus 101, employs the client apparatus 102 to access the printing order reception apparatus 101 via the network 104 and enters a log-in ID and a password. Then, since the orderer successfully logged in to the printing order reception system of the invention, an “initial menu” screen 501 is transmitted to the client apparatus 102 via the network 104 from the printing order reception apparatus 101.

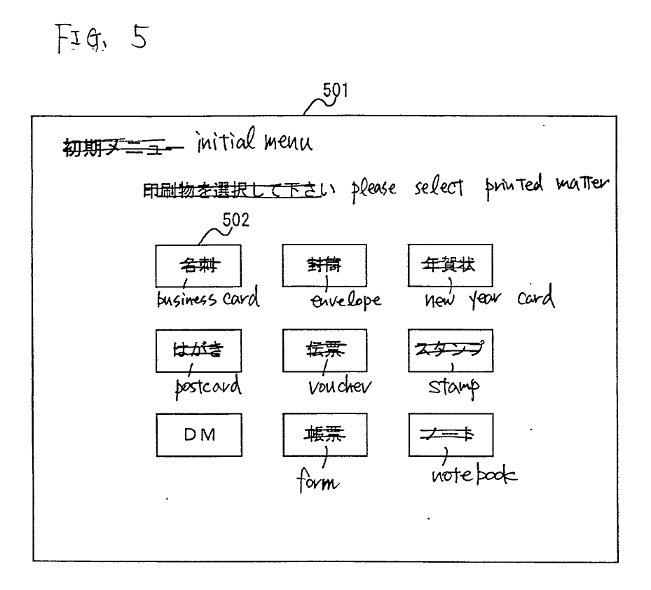

FIG. 5 is a diagram showing an initial menu screen 501 displayed on the client apparatus 102.

As is shown in FIG. 5, the print material types “business card”, “envelope”, “new year's greeting card”, “postcard”, “voucher”, “stamp”, “DM (direct mail”, “form” and “notebook” are displayed on the initial menu screen 501 as buttons, which user can manipulate to select the type of printed matter. The “voucher” and “form” include a receipt, a delivery note, a debit note, a counting note, and the like. When the user manipulates the business card button 502, a “template setting” screen 601 is displayed.

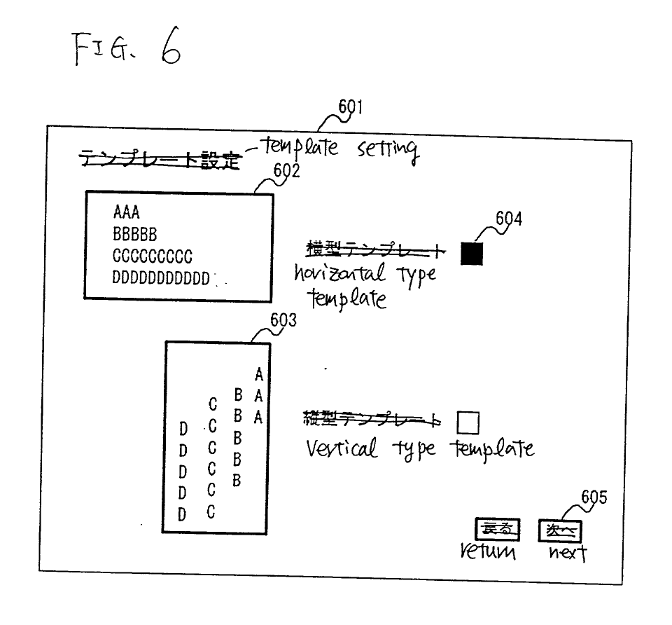

FIG. 6 is a diagram showing the template setting screen 601 displayed on the client apparatus 102.

As is shown in FIG. 6, a horizontal type template 602 and a vertical type template 603 are displayed on the template setting screen 601. In this embodiment, a tick mark is inputted in a “horizontal type template” check box 604 to select the horizontal type template. Then, when a “next” button 605 is operated, a “character information content setting” screen 701 is displayed.

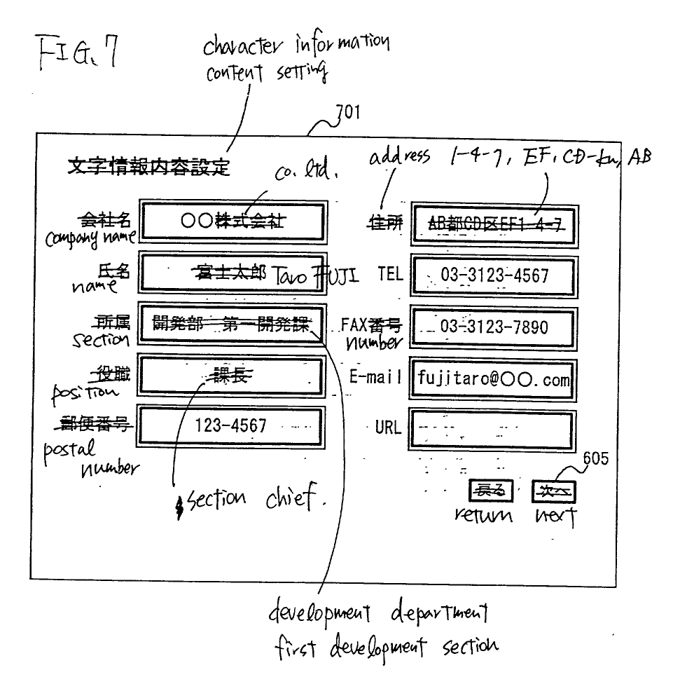

FIG. 7 is a diagram showing the “character information content setting” screen 701 displayed on the client apparatus 102.

As is shown FIG. 7, each of columns of character information is displayed on the “character information contents setting” screen 701.

In this embodiment, “first development section of development department” is inputted as character information of the work section, “section chief” is inputted as the job position, “123-4567” is inputted as the telephone number, “1-4-7, EF, CD-ku, AB” is inputted as the address, and “03-3123-7890” is inputted as the facsimile number, but since the orderer determines that a URL is not required for the business card, there is no URL entry. Then, when the “next” button 605 is manipulated, a “paper setting” screen 801 is displayed.

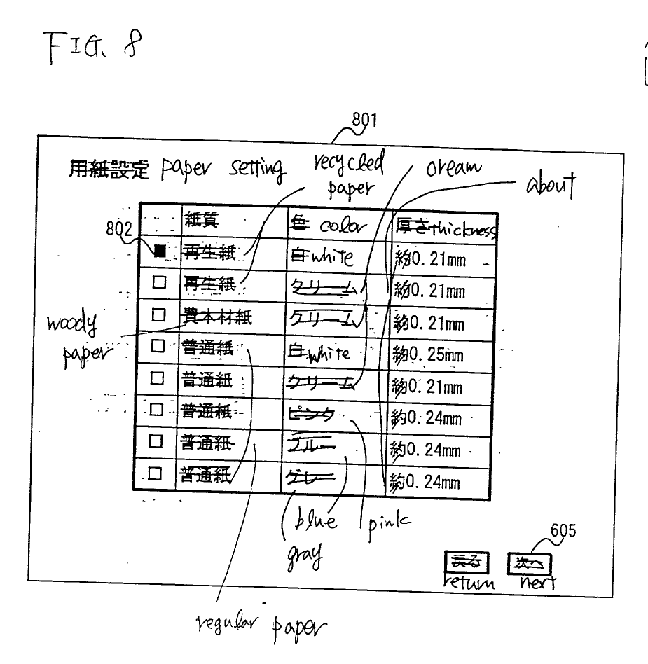

FIG. 8 is a diagram showing the “paper setting” screen 801 displayed by the client apparatus 102.

As is shown in FIG. 8, on the “paper setting” screen 801, information of color and thickness is displayed for several different paper types. In this embodiment, a tick mark is entered in the “recycled paper (white)” check box 802 to select recycled paper (white). Then, when the “next” button 605 is selected, the printing order reception apparatus 101 generates a print image of a business card based on the template selected and the character information inputted by the orderer and transmits the print image to the client apparatus 102 via the network 104. In this embodiment, in order to generate the print data of a business card easily, the orderer employs the default values of the print attribute data of the business card, instead of setting the print attribute data. The orderer may, however, set the print attribute data as desired.

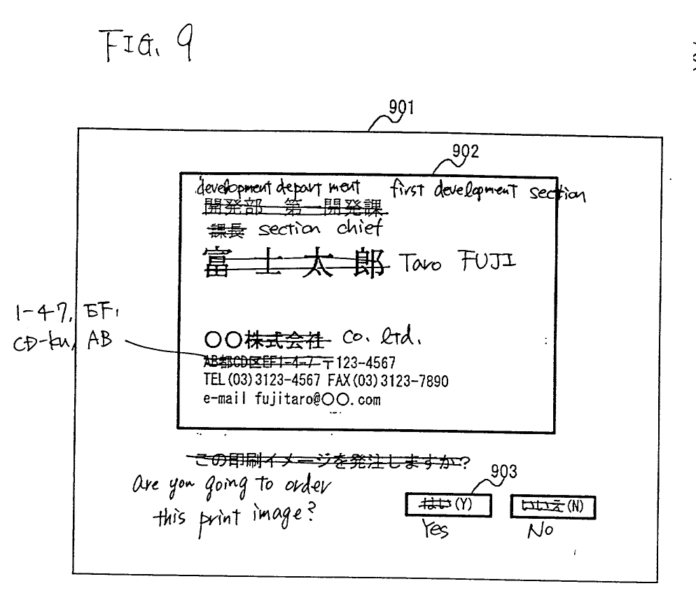

FIG. 9 is a diagram showing a “print image confirmation” screen 901 displayed on the client apparatus 102.

In FIG. 9, a print image of the business card 902 is displayed that is generated based on the template selected and the character information entered by the orderer.

When the orderer examines the print image 902 and determines no corrections are needed, the orderer selects a “yes” button 903, and transmits to the printing order reception apparatus 101, via the network 104, a printing instruction of the print image 902 of the business card.

The printing order reception apparatus 101 then prints a business card based on the template selected and the character information inputted by the orderer, generates an electronic plate for this business card, and accumulates the electronic plate in the printing order reception apparatus 101. In case of the print order as the above described embodiment, the image data of a complicated graphic symbol such as a logo (a representative symbol mark of a company) can not be generated.

Further, except for the above described embodiment, when a business card owned by an orderer is reprinted as it is, there are the steps of mailing the owned business card, reprinting the mailed business card, accumulating character information of the business card and print attribute data such as position of character information printed on the business card in the print order reception apparatus 100, font type, font size, and the like, and generating an electronic plate based on the accumulated the print attribute data. Then the generated electronic plate is stored in the print order reception apparatus. In this case, by using a scanner, the image data of a logo printed on the business card can be easily generated as print content data. Further, the orderer also employs the client apparatus 102 to enter, via the Web, personal information and the number of copies to be printed and the address to which the copies are to be sent. As a result, the reprinting order instruction is transmitted via the network 104 to the printing order reception apparatus 101. The character information to be printed on the business card and the image data of the log may be accumulated in a data recording medium, such as a CD-ROM to mail or may be transmitted via the network 104 to the printing order reception apparatus 101.

In case that the template of the business card and character information is transmitted from the client apparatus 102 to the print order reception apparatus 101 via the network 104 or that the business card is reprinted as it is, the print order reception apparatus, which has received the order instruction, transmits a notification of the order reception to the client apparatus 102 while generating a logo having an appropriate size which can be used for other type of printed matter such as envelope to request permission of applying the generated logo to printing of other type of printed matter. In addition, the printing order reception apparatus 101 also requests permission to print other types of printing material by employing the character information for the business card.

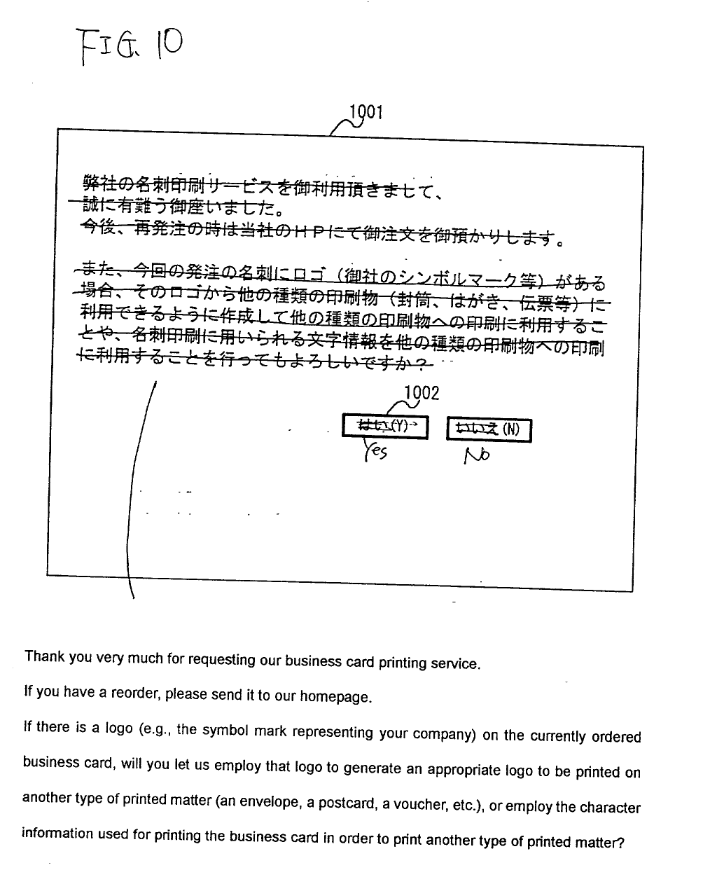

FIG. 10 is a diagram showing an “order receipt” screen 1001 displayed on the client apparatus 102.

As is shown in FIG. 10, when the orderer permits the generation of a logo having an appropriate size that can be used for the printing of other types of printed matter and also permits that the printing of other types of printed matter is used the character information that is used for the printing of business cards, the orderer need only manipulate a “yes” button 1002. Then, permission to use the logo and the character information is transmitted to the printing order reception apparatus 101 via the network 104. In this embodiment, requests for permission to use both the logo and the character information are submitted at the same time; however, these request may be submitted separately.

When the orderer requests confirmation before the print data generated from a business card mailed, as an attachment to an email transmitted to the client apparatus 102, a URL for displaying a print image and a screen for granting permission to use the logo and/or character information on the business card for the printing of another type of printed matter. The orderer then confirms the print image on the screen and notifies the printing order reception apparatus 101 as to whether the use of the logo and the character information for printing another type of printed matter is permitted.

When the orderer places another order to print envelopes using the logo and the character information that are generated for use for the printing of another type of printed matter, the orderer accesses the printing order reception apparatus 101 from the client apparatus 102 via the network 104 and enters the log-in ID and the password. When this is done, the attempt to log in with the printing order reception system of the invention will be successful.

Upon receiving a printing order for envelopes, the printing order reception apparatus 101 generates a print image of an envelope based a logo and character information that are generated from the logo and character information printed on the business card so that the logo and the character information can be used to an envelope and then transmits the print image to the client apparatus 102 via the network 104.

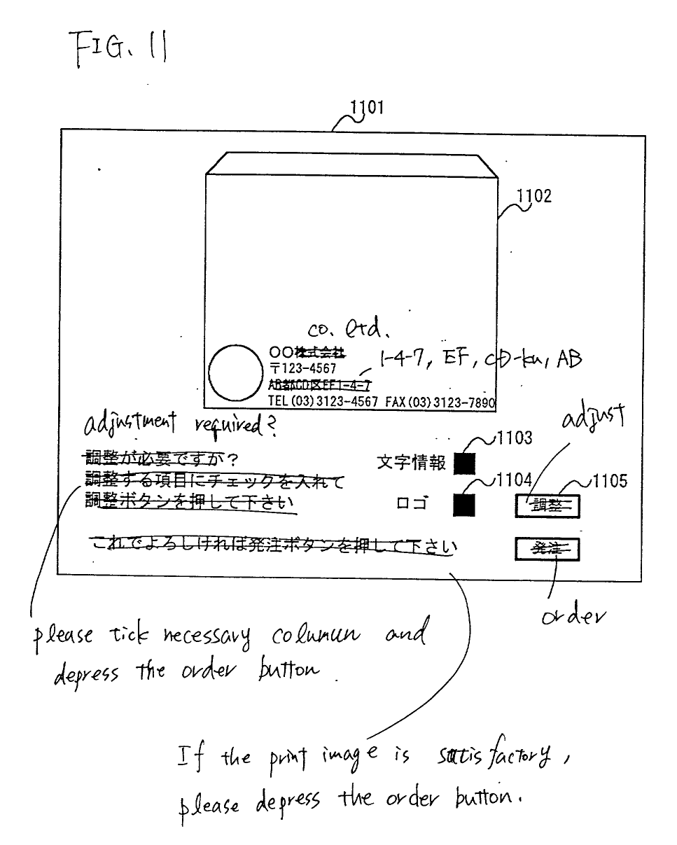

FIG. 11 is a diagram showing a “print image confirmation” screen 1101 displayed on the client apparatus 102.

As is shown in FIG. 11, a print image 1102 of an envelope is displayed that is generated based on the logo and the character information generated from the log and the character information printed on the business card so that the logo and the character information can be used for the envelope.

When the orderer determines that an adjustment of the print image 1102 is required, in order to adjust the character information, the orderer enters a tick mark in a character information check box 1103 or in order to adjust the logo, in a logo check box 1104, and manipulates an adjustment button 1105. Then, the printing order reception apparatus 101 transmits, to the client apparatus 102, a screen that can be used to adjust the logo and the character information.

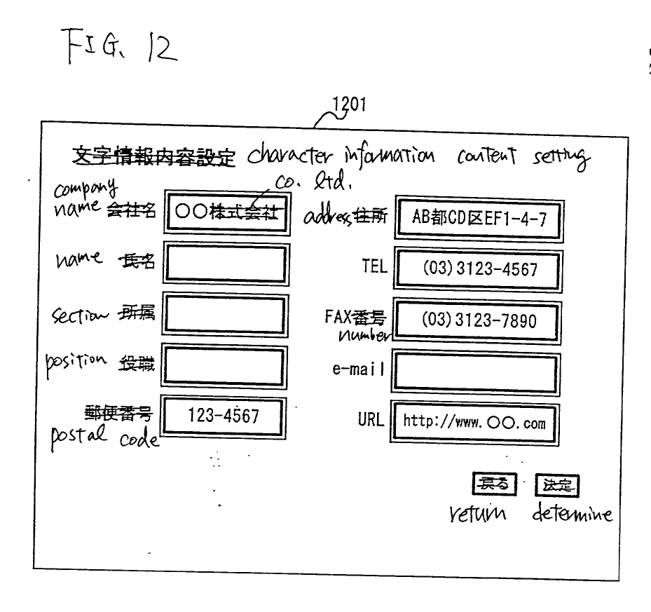

FIG. 12 is a diagram showing a “character information contents setting” screen 1201 displayed on the client apparatus 102.

As is shown in FIG. 12, each of columns of the character information is displayed on the “character information contents setting” screen 1201 and the character information contents are those obtained by copying the character information printed on the business card.

In this embodiment, the character information, such as a company name, a postal code, an address, a telephone number and a facsimile number, that is printed on a business card is copied. It should be noted that in order to print a name, a section name, a postal code, and an e-mail address on an envelope, the character information need only be entered to these columns. Further, in order to print on an envelope a URL that is not present on a business card, the required character information need merely be entered in the URL column.

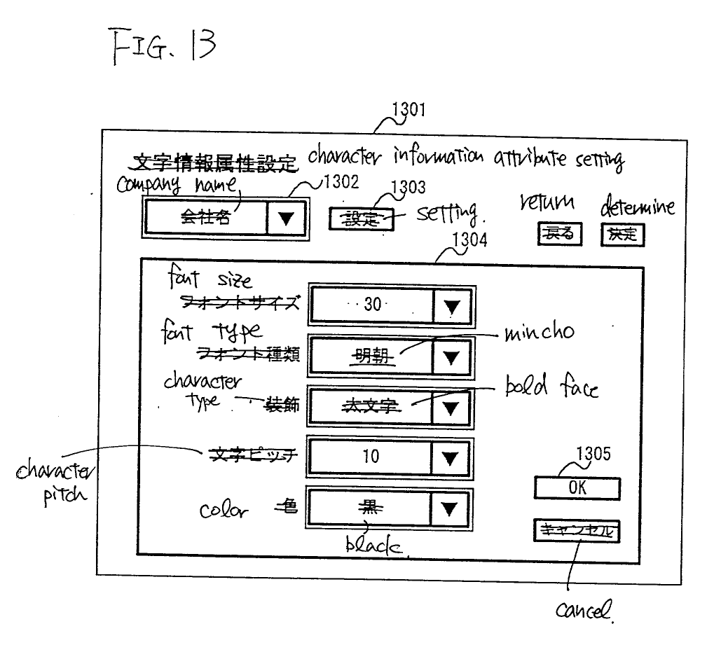

FIG. 13 is a diagram showing a “character information attribute setting” screen 1301 displayed on the client apparatus 102.

As is shown in FIG. 13, an attribute can be set for each character information column on the character information attribute setting screen 1301.

When a character information column for setting an attribute, e.g., a company name column in this embodiment, is selected by using a combo box 1302 and a “set” button 1303 is manipulated, an attribute setting command 1304 is displayed. The font size, the font type, the character type, the character pitch and the color of the company name, which constitutes the character information, are designated and an “OK” button 1305 is manipulated and as a result, the attribute is set for the company name constituting the character information.

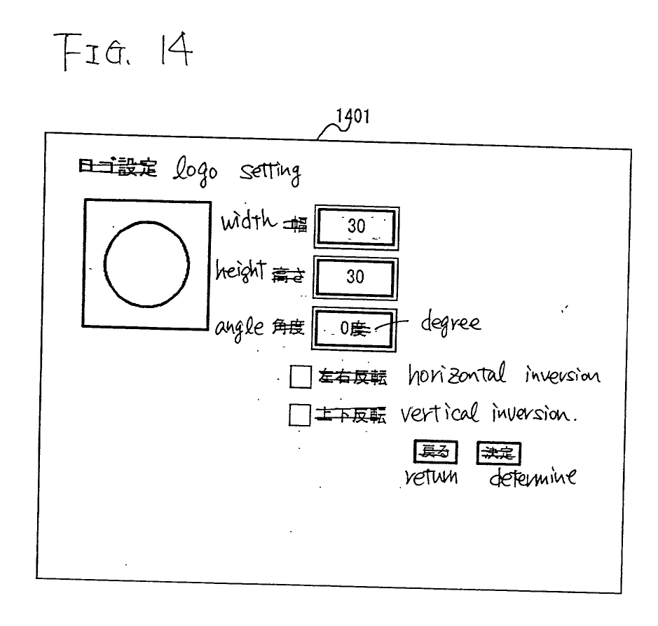

FIG. 14 is a diagram showing a “logo setting” screen 1401 displayed on the client apparatus 102.

As is shown in FIG. 14, the width, the height and the angul of a logo, and the horizontal or the vertical inversion of the logo can be designated using the logo setting screen 1401.

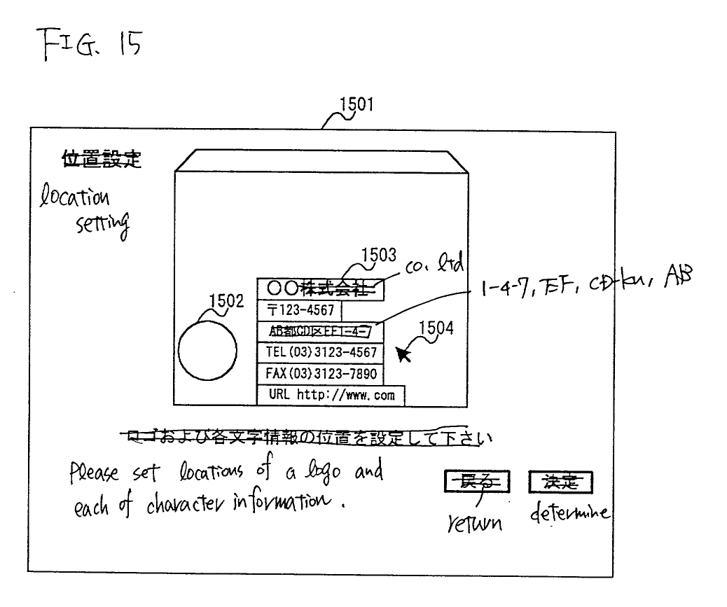

FIG. 15 is a diagram showing a “location setting” screen 1501 displayed on the client apparatus 102.

As is shown in FIG. 15, the locations of a logo 1502 and character information 1502 (in this embodiment, a company name, a postal code, an address, a telephone number, a facsimile number and a URL) are clicked on using a mouse pointer 1504 and then the mouse pointer 1504 is moved. Whereby, the positions on the envelope of the logo 1502 and the character information 1503 can be designated.

After the character information contents, the character information attribute, the logo and the positions of the character information and the logo are designated, all of the required data is transmitted to the printing order reception apparatus 101, via the network 104, as instruction data for correction of the attribute information. The printing order reception apparatus 101 employs the received data to update the print content data and/or the print attribute data for an envelope, and the printing order reception apparatus 101 then generates a print image for an envelope based on the updated print content data and print attribute data, transmits the print image to the client apparatus 102, via the network 104, and stores the print content data and the print attribute data.

In addition, the printing order reception apparatus 101 copies part of the print attribute data for the envelope to the print attribute data table, wherein default values of printed matter other than an envelope are entered, and stores the data in the table. At this time, the printing order reception apparatus 101 may transmit, to the client apparatus 102, a screen used to grant permission to employ the newly set print content data and the print attribute of the envelope to print another type of printed matter.

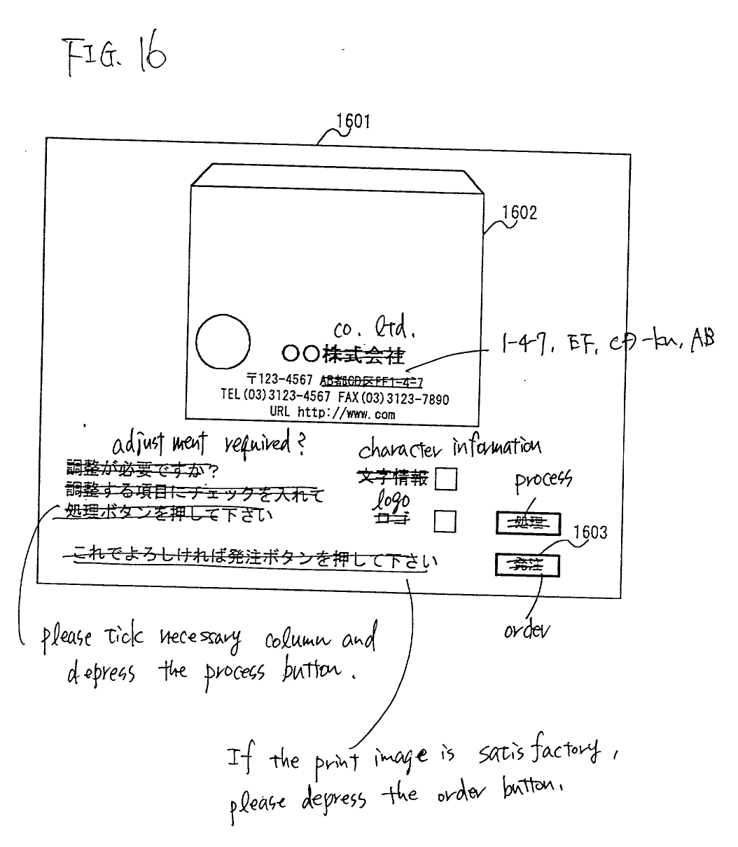

FIG. 16 is a diagram showing a “print image confirmation” screen 1601 displayed on the client apparatus 102.

As is shown in FIG. 16, a print image 1602 is displayed for an envelope that is generated based on the print content data and the print attribute data that are newly set for an envelope.

When the orderer determines that no adjustments are required for the print image 1602 and selects an “order” button 1603, the envelope printing order is transmitted, via the network 104, to the printing order reception apparatus 101. However, when adjustments are required, the process described above is employed, and then the print content data and/or the print attribute data of the envelope is updated based on the data obtained by making the adjustment. Subsequently, regeneration of the print image is performed based on the updated data, and the image is transmitted to the client apparatus 102.

Upon receiving the envelope printing order, the printing order reception apparatus 101 generates an electronic plate based on the new print attribute data for the envelope, and adds the new print content data for the envelope to the electronic plate to generate print data. The print data are thereafter transmitted to the printing machine 103 via the network 104.

In the above embodiment, one print content data table is provided that is commonly used for the printing of multiple types of print materials. However, in addition to the print attribute table, a print content data table may be provided for each type of print material. In this case, when the print content data of business cards are accumulated in a print content data table, the data is copied to the print content data table for the printing of envelopes, so that the print content data can be managed for the printing of each material.

Further, in this embodiment, the attribute information has been copied in advance, and a copy of the attribute information has been updated in accordance with instruction information. However, this imposes no limits on the present invention. The instruction information may be accumulated and the attribute information corrected in accordance with this instruction information in order to generate a print image or print data. In this case, multiple print attribute tables are not required.

As is described above, according to the present invention, by employing the print content data and print attribute data that are stored in the printing order reception apparatus for a printing material, an order for printing another type of printing material can be coped with.

What is claimed is:

1. A printing order reception method for accepting an order of a printed matter via network comprising the steps of:
storing print content data used in a case of printing a first type of printing medium;
generating print data to be printed on a second type of printing medium by using the stored print content data; and
transmitting the generated print data to an external device.

2. The printing order reception method according to claim 1, further comprising the steps of:
generating a print image to be printed on the second type of printing medium; and
transmitting the generated print image to a network terminal.

3. The printing order reception method according to claim 2, further comprising the steps of storing attribute information of the print content data; and
generating the print image by using at least a part of the attribute information stored.

4. The printing order reception method according to claim 2, further comprising the step of:
copying at least a part of the attribute information as second attribute information.

5. The printing order reception method according to claim 4, further comprising the step of:
generating the print image by using the second attribute information.

6. The printing order reception method according to claim 4, further comprising the steps of:
accepting instruction information instructing correction of the second attribute information from the network terminal; and
correcting the second attribute information in accordance with the accepted instruction information.

7. The printing order reception method according to claim 3, further comprising the step of:
generating the print image by using the attribute information and attribute information stored in advance and used for the generation of the print data.

8. The printing order reception method according to claim 3, further comprising the steps of:
receiving instruction information instructing correction of the attribute information from the network terminal; and
storing the received instruction information.

9. The printing order reception method according to claim 3, further comprising the steps of:
receiving instruction information instructing correction of the attribute information from the network terminal;
regenerating the print image in accordance with the received instruction information; and
transmitting the regenerated print image to the network terminal.

10. The printing order reception method according to claim 3, further comprising the steps of:
receiving instruction information instructing correction of the attribute information from the network terminal; and
generating the print data in accordance with the received instruction information.

11. The printing order reception method according to claim 2, wherein the print image is the same as the print data.

12. The printing order reception method according to claim 1, further comprising the steps of:
storing attribute information of the print content data used to print the first type of printing medium; and
generating the print data by using at least a part of the stored attribute information.

13. The printing order reception method according to claim 12, further comprising the step of:
copying at least a part of the attribute information as second attribute information.

14. The printing order reception method according to claim 13, further comprising the step of:
generating the print data by using the second attribute information.

15. The printing order reception method according to claim 12, further comprising the step of:
generating the print image by using the attribute information and attribute information stored in advance and used for the generation of the print data.

16. A printing order reception apparatus for accepting an order of a printed matter via a network comprising:
a print content data storage unit for storing print content data used when printing a first type of printing medium;
a print data generation unit for employing the print content data stored by the print content data storage unit to generate print data to be printed on a second type of printing medium; and
an external apparatus transmission unit for transmitting the print data generated by the print data generation unit to an external device.

17. The printing order reception apparatus according to claim 16, further comprising:
a print image generation unit for generating a print image to be printed on the second type of printing medium; and
a network terminal transmission unit for transmitting the print image generated by the print image generation unit to a network terminal.

18. The printing order reception apparatus according to claim 17, further comprising an attribute information storage unit for storing attribute information of the print content data,
wherein the print image generation unit generates the print image by using at the least a part of the attribute information stored in the attribute information storage unit.

19. The printing order reception apparatus according to claim 18, further comprising a copying unit for copying at least a part of the attribute information as second attribute information.

20. The printing order reception apparatus according to claim 19, wherein the print image generation unit employs the second attribute information to generate the print image.

21. The printing order reception apparatus according to claim 19, further comprising:
an instruction information acceptance unit for accepting instruction information instructing correction of the second attribute information from the network terminal; and
a second attribute information correction unit for correcting the second attribute information in accordance with the instruction information accepted by the instruction information acceptance unit.

22. The printing order reception apparatus according to claim 18, wherein the print image generation unit generates the print image by using the attribute information and attribute information stored in advance and used for the generation of the print data.

23. The printing order reception apparatus according to claim 18, further comprising:
an instruction information acceptance unit for receiving instruction information instructing correction of the attribute information from the network terminal; and
an instruction information storage unit for storing the instruction information received by the instruction information acceptance unit.

24. The printing order reception apparatus according to claim 18, further comprising:
an instruction information acceptance unit for receiving instruction information instructing correction of the attribute information from the network terminal; and
a print image regeneration unit for regenerating the print image in accordance with the instruction information received by the instruction information acceptance unit,
wherein the network terminal transmission unit transmits the print image regenerated by the print image regeneration unit to the network terminal.

25. The printing order reception apparatus according to claim 18, further comprising an instruction information acceptance unit for receiving instruction information instructing correction of the attribute information from the network terminal,
wherein the print data generation unit generates the print data in accordance with the instruction information received by the instruction information acceptance unit.

26. The printing order reception apparatus according to claim 17, wherein the print image is the same as the print data.

27. The printing order reception apparatus according to claim 16, further comprising an attribute information storage unit for storing attribute information of the print content data used to print the first type of printing medium,
wherein the print data generation unit generates the print data by using at least a part of the attribute information stored in the attribute information storage unit.

28. The printing order reception apparatus according to claim 27, further comprising a copying unit for copying at least a part of the attribute information as second attribute information.

29. The printing order reception apparatus according to claim 28, wherein the print data generation unit employs the second attribute information to generate the print data.

30. The printing order reception apparatus according to claim 27, further comprising a print image generation unit for generating the print image by using the attribute information and attribute information stored in advance and used for the generation of the print data.
